(19) United States
(12) Patent Application Publication
(10) Pub. No.: US 2020/0009548 A1
(43) Pub. Date: Jan. 9, 2020

(54) DROPPER DISPENSER

(71) Applicant: APTAR FRANCE SAS, LE NEUBOURG (FR)

(72) Inventor: Frédéric DUQUET, Crespieres (FR)

(73) Assignee: APTAR FRANCE SAS, LE NEUBOURG (FR)

(21) Appl. No.: 16/482,777

(22) PCT Filed: Feb. 1, 2018
(86) PCT No.: PCT/FR2018/050235

§ 371 Date: Aug. 1, 2019

(30) Foreign Application Priority Data
Feb. 2, 2017 (FR) 1750855

(51) Int. Cl. B01L 3/02; F16K 23/00; B05B 11/00; B65D 47/18; B65D 47/20; B65D 51/18

(52) U.S. Cl. CPC B01L 3/0265; F16K 23/00; B05B 11/007; B65D 47/18; B65D 47/2031; B65D 51/18; B65D 2251/0087; B01L 2300/04; B01L 2200/0615; B01L 2300/049; B01L 2400/0638; B01L 2400/0481; B65D 2251/0015; B01L 2400/049

(57) ABSTRACT

A dropper dispenser comprising:
a fluid reservoir (1) including at least one movable wall (11) so as to put the fluid in the reservoir (1) under pressure;
a cannula (24) having an outlet (25) that is designed to form a drop of fluid; and
a valve (3) that is arranged between the reservoir (1) and the cannula (24) so as to control firstly the flow of fluid from the reservoir (1) into the cannula (24), and secondly the flow of fluid, and possibly air, from the cannula (24) into the reservoir (1), the valve (3), when subjected to sufficient pressure from the fluid in the reservoir (1), defining an opening (33) having a flow section that is proportional to the force exerted on the movable wall (11) of the reservoir (1);
the dropper dispenser being characterized in that it further comprises a valve-opening limiter (27) so as to limit the opening (33) of the valve (3) while fluid is flowing from the reservoir (1) into the cannula (24), so as to create additional head loss that reduces the flow of fluid through the cannula (24).

The present invention relates to a dispenser of the dropper type that makes it possible to dispense a fluid in drop form. The drops are dispensed one after another. Each drop falls from the dispenser by gravity onto a desired application surface. Advantageous fields of application of the present invention are the fields of perfumery, cosmetics, and pharmacy, not to mention food.

In the prior art, document DE 20 2016 102 192 U1 is already known, and it enables drops to be dispensed, one by one, by squeezing a deformable reservoir that is provided with a valve and a cannula. In order to dispense a drop, the user takes hold of the reservoir and turns it upside-down: the fluid that it contains is held in the reservoir by means of the valve that is closed at rest. When the user squeezes the reservoir, the fluid that it contains is put under pressure, thereby causing the valve to open. The fluid can then flow through the cannula that is designed to form a drop of fluid at its free end, which drop detaches from the cannula by gravity. When the drop is deposited on the desired application surface, the user can relax the pressure on the reservoir and turn it the right way up, so that the fluid that fills the cannula is sucked into the reservoir through the valve that is forced into its open state. Once the cannula is emptied, air is then sucked into the reservoir through the cannula and the valve. The reservoir thus returns to its initial shape. The valve of that document is a two-way valve that includes a self-sealing slot in the shape of a cross, defined by four adjacent flexible flaps. At rest, the cross-shaped slot is closed in leaktight manner. While fluid is being dispensed, the valve opens defining a cross- or star-shaped passage between the flexible flaps. During the suction stage, the same applies, except that the flaps are deformed in the other direction. As a result, the flow section is practically the same during the dispensing stage as during the suction stage. It should also be observed that, during the dispensing stage, the flow section of the valve is directly proportional to the squeezing force exerted by the user on the reservoir.

The problem with that type of dispenser is as follows: in order to guarantee sufficient suction, it is necessary to have minimum head loss through the valve, and to do this it is necessary for the valve to be able to open wide so as to define a large flow section. However, a valve that opens wide during the suction stage, also opens just as wide during the dispensing stage, which leads to a large flow of fluid through the cannula. It is thus difficult to form distinct drops: a small continuous jet is generally obtained, and the harder the reservoir is squeezed the stronger the jet.

An obvious solution would be to reduce the flow section of the valve so as to have high head loss through the valve and thus guarantee dispensing in the form of distinct drops. However, that poses a problem in the suction stage, since the high head loss through the valve prevents the reservoir returning to its initial rest shape.

An object of the present invention is to overcome the above-mentioned drawback of the prior art by defining a valve dispenser that firstly guarantees dispensing in the form of distinct drops, and secondly enables the reservoir to return to its initial rest shape. Another object of the present invention may be defined as seeking asymmetrical operation for the valve. Still another object of the present invention is to start from the dispenser in document DE 20 2016 102 192 U1 without making major changes thereto.

To achieve these objects, the present invention proposes a dropper dispenser comprising: a fluid reservoir including at least one movable wall so as to put the fluid in the reservoir under pressure; a cannula having an inlet that is fed with fluid and an outlet that is designed to form a drop of fluid; and a valve that is arranged between the fluid reservoir and the cannula so as to control firstly the flow of fluid from the reservoir into the cannula, and secondly the flow of fluid, and possibly air, from the cannula into the reservoir, the valve remaining closed in the absence of sufficient fluid pressure, the valve, when subjected to sufficient pressure from the fluid in the reservoir, defining an opening having a flow section that is proportional to the force exerted on the movable wall of the reservoir; the dropper dispenser being characterized in that it further comprises a valve-opening limiter so as to limit the opening of the valve while fluid is flowing from the reservoir into the cannula, so as to create additional head loss that reduces the flow of fluid through the cannula.

Thus, by means of the valve-opening limiter, the valve no longer behaves in the same way during the dispensing stage and during the suction stage. Specifically, the valve can open freely and widely during suction stages, whereas its opening is limited by the valve-opening limiter during dispensing stages. In use, the effect is as follows: the user must squeeze hard on the movable wall of the reservoir in order to cause fluid to flow through the valve having an opening that is limited, thereby making it possible to guarantee the formation of distinct drops. However, once the user relaxes the pressure on the reservoir, the fluid present in the cannula is quickly sucked into the reservoir through the valve that opens freely and widely. In other words, the valve with its opening limiter creates much higher head loss during dispensing stages than during suction stages.

According to an advantageous characteristic of the invention, the valve-opening limiter includes an abutment zone against which the valve comes into abutment while fluid is flowing from the reservoir into the cannula. In other words, the valve can open only in limited manner during dispensing stages. Its stroke is truncated as a result of coming into abutment against the opening limiter.

In another advantageous aspect of the invention, the valve-opening limiter may be situated at the inlet of the cannula. It can thus be said that the valve with its opening limiter directly controls feed to the cannula.

In an advantageous embodiment, the valve-opening limiter is formed integrally with the cannula. Advantageously, the abutment of the valve against the limiter creates leaktight annular contact around the inlet of the cannula. This embodiment is advantageous since it does not require any additional parts. Specifically, it is the cannula itself that forms the limiter at its inlet. Leaktight annular contact around the inlet is advantageous, since it prevents the fluid from spreading around the valve.

In another embodiment, the valve-opening limiter may be formed by a separate part that is interposed between the valve and the cannula.

In another advantageous aspect of the invention, the valve-opening limiter forms a flow-section constriction towards the cannula. Thus, in addition to limiting the flow section of the opening of the valve, the opening limiter may itself reduce the flow section to the cannula.

In another advantageous aspect of the invention, the dispenser may further comprise adjustment means for adjusting the position of the valve-opening limiter relative to the valve. The user can thus adjust as desired the extent to which the valve opens. For example, the user may adjust the position of the opening limiter as a function of the maximum force that the user can exert in order to squeeze the reservoir.

In a practical embodiment, the valve comprises a deformable movable wall that is pierced by a cross-shaped slot that defines adjacent flexible flaps, the deformable movable wall coming into abutment against the valve-opening limiter, at least one portion of the flexible flaps advantageously coming into abutment against the valve-opening limiter. Advantageously, the valve further comprises an anchor collar that is mounted in stationary manner relative to the reservoir, and an annular flexible membrane that connects the anchor collar to the deformable movable wall, such that the deformable movable wall is moved relative to the anchor collar by deforming the annular flexible membrane under the effect of the flow of fluid in one direction or in the other. This valve is substantially similar, and may even be identical, to the valve in the above-mentioned document DE 20 2016 102 192 U1.

In another advantageous aspect of the invention, the valve presents two distinct flow sections, namely a first flow section for dispensing while fluid is flowing from the reservoir into the cannula, and a second flow section for suction while fluid, and possibly air, is/are flowing from the cannula into the reservoir, the first flow section for dispensing being limited by the valve-opening limiter, such that it is less than the second flow section for suction. Advantageously, the first flow section for dispensing is three to four times smaller than the second flow section for suction. Thus, the present invention may also be embodied in the form of a two-way valve having a flow section that is asymmetrical, as a result of using a characteristic having a function or consequence of limiting the flow section in one direction, and not in the other.

The spirit of the invention is to cause a two-way valve to have flow sections that differ by using a valve-opening limiter that operates in only one direction of flow. The asymmetrical two-way valve finds an advantageous application in a dropper dispenser, since it makes it possible to have a slow or controlled flow for forming drops, and a quick and powerful flow for emptying the cannula of its contents by suction. Such an asymmetrical two-way valve may be used in other devices, and protection for the valve proper might be sought.

The invention is described below in greater detail with reference to the accompanying drawings, which show several embodiments of the invention as non-limiting examples.

In the figures:

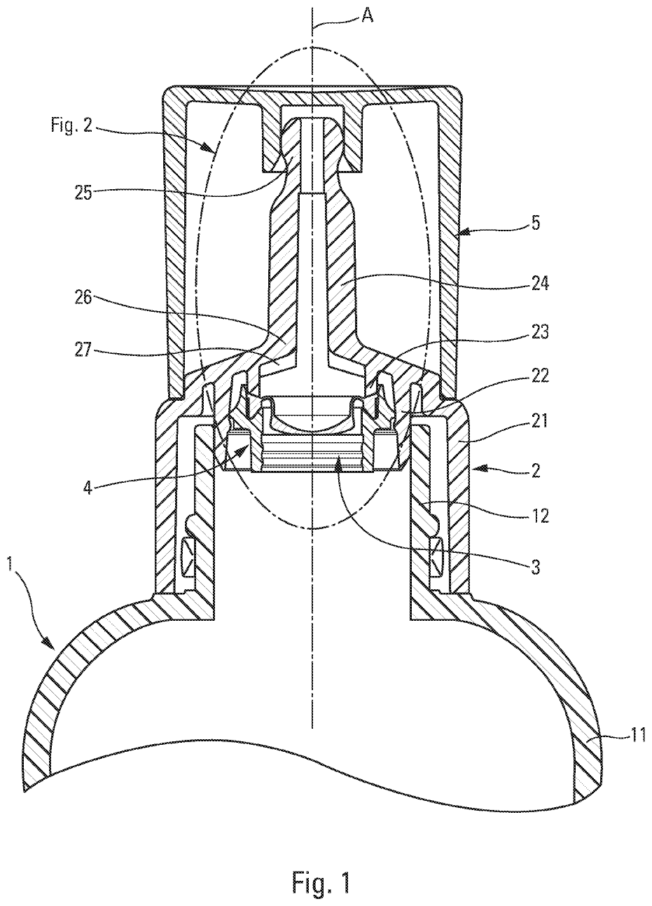

FIG. 1 is a vertical-section view through a dropper dispenser constituting a first embodiment of the invention, in the rest state;

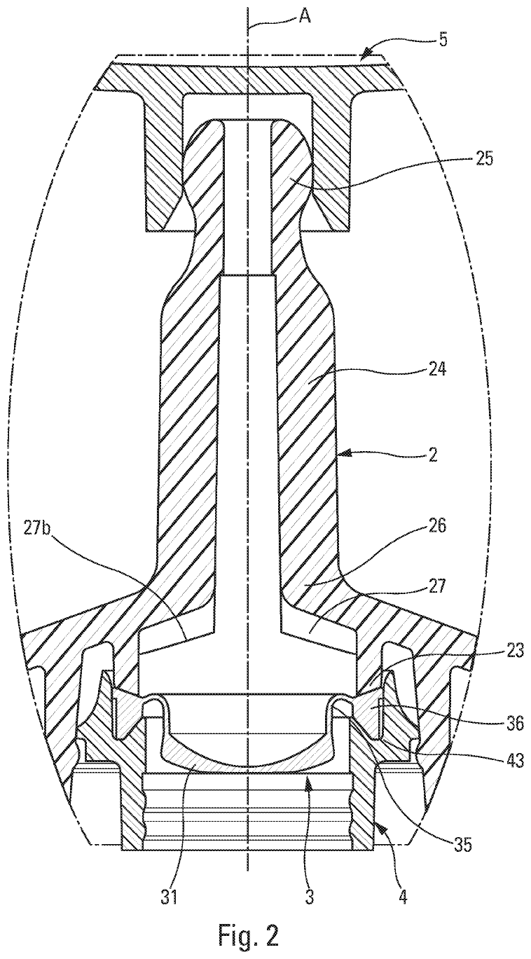

FIG. 2 is a larger-scale view of a detail encircled in FIG. 1;

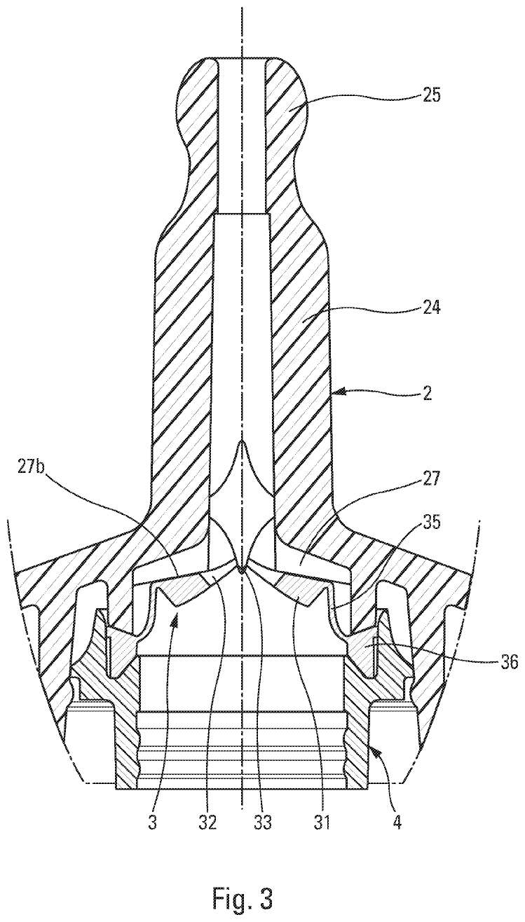

FIG. 3 is a view similar to the view in FIG. 2, during a fluid dispensing stage;

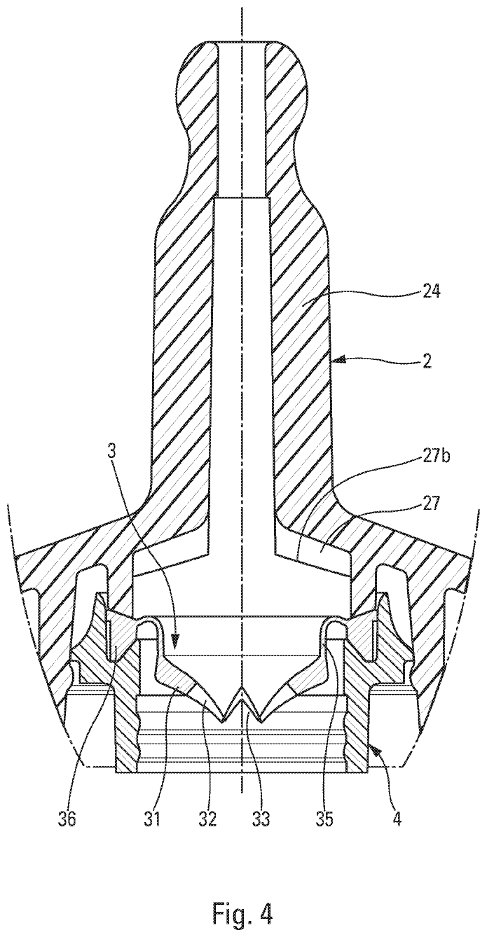

FIG. 4 is a view similar to the views in FIGS. 2 and 3, during a fluid suction stage;

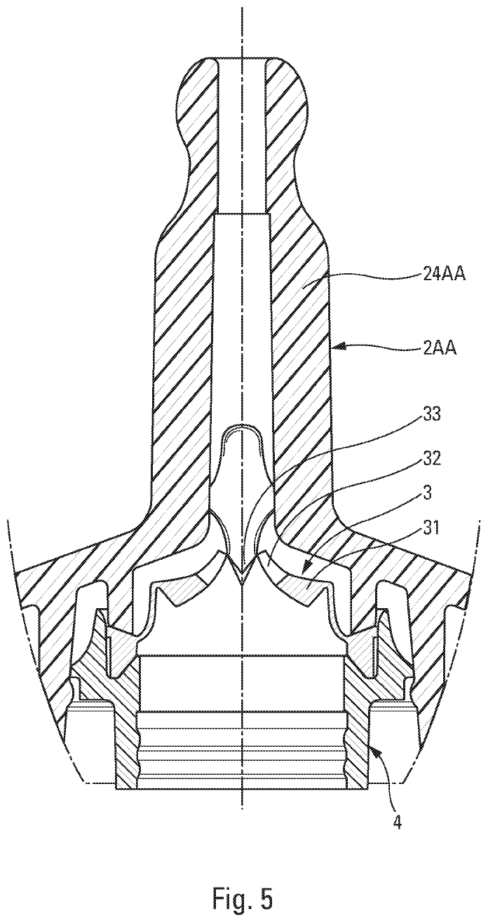

FIG. 5 is a view similar to the views in FIGS. 2 to 4 for a prior-art dispenser that does not have a valve-opening limiter;

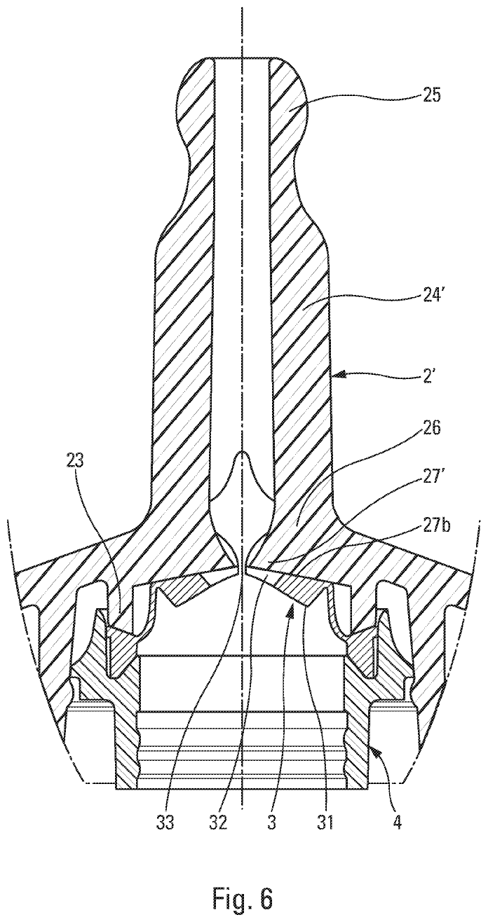

FIG. 6 is a view similar to the views in FIGS. 2 to 5 for a second embodiment of the invention;

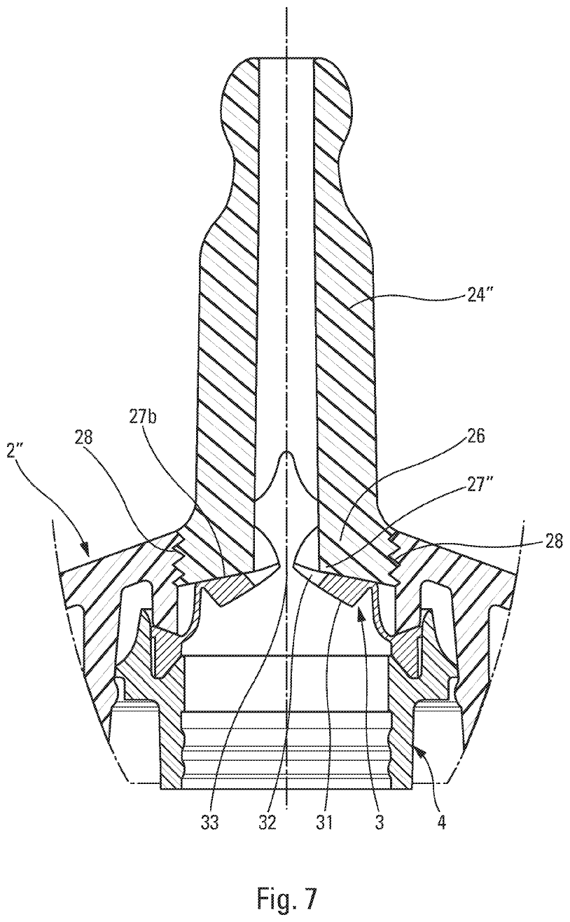

FIG. 7 is a view similar to the views in FIGS. 2 to 6 for a third embodiment of the invention; and

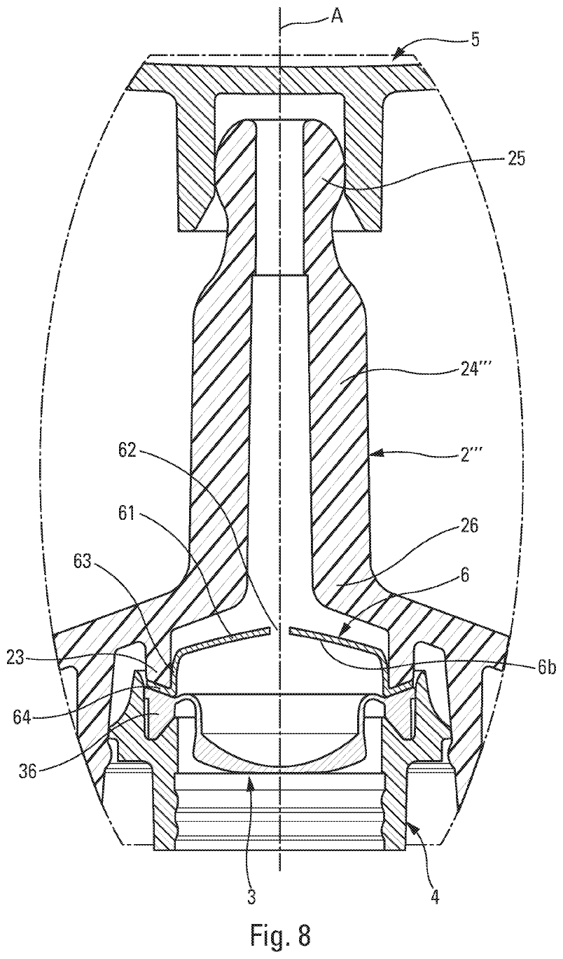

FIG. 8 is a view similar to the view in FIG. 2 for a fourth embodiment of the invention.

Whatever the embodiment, the dropper dispenser of the invention comprises the following component elements, namely a fluid reservoir, a dispenser head, a two-way valve, and optionally a protective cap. Furthermore, a support bushing may be used to hold the valve.

With reference to FIG. 1, the fluid reservoir 1 can be seen in truncated manner. Nevertheless, it can be seen that the reservoir 1 comprises a wall 11 and a neck 12. In this embodiment, the wall 11 is movable, so as to be suitable for being deformed by sufficient pressure exerted by the user. The reservoir may be said to be “squeezable”, another term is “squeeze bottle”. By way of example, this type of reservoir having a deformable wall may be made by injecting/blowing an appropriate plastics material.

Instead of the container having a squeezable wall, it is also possible to use a reservoir having a movable wall that is formed by a piston that slides in an appropriate cylinder. Thus, by pushing the piston in the cylinder, the fluid contained in the reservoir is put under pressure.

In actual fact, the particular type of reservoir is not critical to the present invention, providing the reservoir includes a movable wall that makes it possible to put the contents of the reservoir under pressure.

Reference is made below to FIGS. 1 to 4 in order to describe in detail a dispenser head 2 in a first embodiment of the invention. Furthermore, the other embodiments that are described below have dispenser heads of the same general structure. That is why only the differences relative to the first embodiment are described.

The dispenser head 2 includes a fastener skirt 21 that is suitable for coming into engagement with the neck 12 of the reservoir 1 so as to achieve stable, and possibly permanent, fastening. The dispenser head 2 also includes a mounting and sealing lip 22 that extends coaxially inside the skirt 21, so as to come into leaktight engagement with the inside of the neck 12. Sealing is thus provided between the reservoir 1 and the dispenser head 2. The dispenser head 2 also includes an annular holding flange 23 that extends coaxially inside the lip 22. Finally, the dispenser head 2 includes a cannula 24 that extends upwards, away from the skirt 21, the lip 22, and the flange 23. The cannula 24 includes an internal passage that passes right through it. The cannula includes an outlet 25 that is formed at its top free end, and that is designed to form a drop of fluid. Specifically, it should be observed that the outlet 25 presents an outer shape that is rounded so as to impart thereto a shape that is substantially spherical. This design is conventional for a drop-dispensing endpiece within a dropper dispenser. The cannula 24 also includes an inlet 26 that is adjacent to the annular flange 23. It should be observed that the inlet 26 is provided with a plurality of radial ribs or fins 27 that extend in the shape of a star all around the hollow inside of the cannula 24. The ribs or fins 27 are formed just below the inlet 26 and they extend until they come into contact with the annular flange 23. It should be observed that the ribs or fins 27 do not reduce the flow section of the internal passage of the cannula 24. The fins or ribs 27 may be considered as downward extensions of the inlet 26 of the cannula 24. The function of the ribs or fins 27 is described below.

The valve 3 could be fastened directly to the dispenser head 2 at its annular flange 23, or at its sealing lip 22. However, in this particular embodiment, the dropper dispenser uses a support bushing 4 that is snap-fastened inside the sealing lip 22 and that includes an annular reception housing 43 that is suitable for receiving a portion of the valve 3 so as to press it firmly against the bottom free end of the annular holding flange 23. This can be seen more clearly in FIG. 2. Naturally, it is possible to envisage other means and other techniques for holding the valve 3 inside the dispenser head 2: the support bushing 4 constitutes only one illustrative example.

The valve 3 that is used in the dropper dispenser of the invention should not be considered as limiting. Other types of valve can be used in the context of the invention. However, in this particular and advantageous embodiment, the valve 3 includes a deformable movable wall 31 that, at rest, presents a concave dish shape. It should be observed that the thickness of the deformable movable wall 31 is not constant, since it is thinner at its center than at its edges. The deformable movable wall 31 is pierced by a slot 33 that is cross-shaped in this embodiment. This can be seen more clearly in FIGS. 3 and 4. The slot 33 is defined by four adjacent flexible flaps 32, each of which is in the shape of a slice of pie. At rest, as shown in FIG. 2, the four adjacent flexible flaps 32 are completely touching, such that the cross-shaped slot 33 is completely closed and even invisible. In contrast, when the deformable movable wall 31 is subjected to a fluid under sufficient pressure, the four adjacent flexible flaps move apart so as to define an opening 33 in the shape of a cross or a star having four branches. This is shown in diagrammatic manner in FIGS. 3 and 4. It can thus be said that the opening of the valve 3 is formed by the cross-shaped slot 33 that is open to a greater or lesser extent.

The valve 3 also includes an anchor collar 36 that is in place in the annular reception housing 43 of the mounting bushing 4, and that is compressed by the annular holding flange 23. It can also be said that the anchor collar 36 is wedged between the bushing 4 and the flange 23. Sufficient fastening and sealing is thus created. In addition, the movable wall 31 is connected to the anchor collar 36 via an annular flexible membrane 35 that presents a small thickness. The deformable movable wall 31 may thus move between a dispensing position shown in FIG. 3 and a suction position shown in FIG. 4. It should be observed that the deformable annular membrane 35 extends upwards from the anchor collar 36 in FIG. 3, while the same membrane 35 is folded or turned downwards in FIG. 4. It can thus be said that the annular membrane 35 can be turned upwards from its rest position (FIG. 2) in order to reach its dispensing position (FIG. 3). Then, the membrane can return to its rest position in which the deformable movable wall 31 may be deformed, as shown in FIG. 4, during a fluid suction stage.

A complete operating cycle of the dropper dispenser is described below with reference to FIGS. 2, 3, and 4. In FIG. 2, the valve 3 is in its rest position, with its flaps 32 touching and its cross-shaped slot completely closed. The wall 31 thus gives the impression of not being pierced. It is completely leaktight. The fluid stored in the reservoir 1 is thus isolated from the outside by the valve 3, in its closed state. It should also be observed that the valve 3 is not in contact with the ribs or fins 27 that are formed at the inlet 26 of the cannula 24.

When a user wishes to use the dispenser, the user begins by removing the protective cap 5, so as to release or unmask the dispenser head 2, and more particularly its cannula 24. The user may take hold of the dispenser by the reservoir 1, but without squeezing its movable wall 11 yet. The user then turns the dispenser upside-down so that the outlet 25 of the cannula 24 is oriented substantially downwards. The fluid contained in the reservoir 1 then comes into contact with the valve 3, but since the valve is closed, it prevents any fluid from flowing through the cannula 24. At this moment, the user can squeeze the movable wall 11 of the reservoir 1, so as to put the fluid that it contains under pressure. Initially, the deformable movable wall 31 moves upwards by deforming the flexible membrane 35. The cross-shaped slot 33 still remains closed. The deformable wall 31 continues to move until it comes into abutment against an abutment zone 27b that, in this embodiment, is formed by the bottom edges of the ribs or fins 27. The slot 33 is still closed. By squeezing harder on the movable wall 11, the pressure of the fluid on the wall 31 caused to increase until the wall deforms, moving the flexible flaps 32 apart so as to define between them an opening 33 in the form of a cross- or star-shaped slot having four branches. Given that the wall 31, and even a portion of the flexible flaps 32 are thrust into abutment against the abutment zone 27b of the fins 27, the opening of the valve 3 is constricted or limited, thereby creating increased head loss. In other words, the ribs or fins 27 perform the function of an opening limiter for limiting the opening of the valve 3 by preventing the flexible flaps 32 from moving further apart. A small quantity of fluid is thus forced through the hollow inside of the cannula 24, so that it is easier to guarantee the formation of distinct drops. The user must squeeze hard on the deformable reservoir 1 in order to dispense distinct drops.

Once the user has dispensed the number of drops that are required, the user begins to relax the squeezing pressure on the reservoir 1, such that the valve 3 closes and the deformable wall 31 moves towards its rest position in FIG. 2. However, given that the reservoir 1 is under suction, the valve 3 is caused to open in the other direction, as shown in FIG. 4. The fluid contained in the cannula 24 is thus sucked into the reservoir 1 through the opening 33 of the valve 3. Finally, the outside air may also penetrate into the reservoir through the cannula 24 and the open valve 3. However, in FIG. 4, it should be observed that the opening 33 of the valve 3 is much larger than the opening in FIG. 3. Specifically, there is nothing to limit or restrict the deformation of the flaps 32, so they can move apart freely and thus define a flow opening having a section that depends directly on the suction that exists inside the reservoir 1. The opening limiter 27 is completely without function during this suction stage.

It should thus be observed that the valve 3 is a two-way valve in the sense that it opens during dispensing stages and during suction stages, but does so in asymmetrical manner, given that its opening during dispensing stages is limited by the fins or ribs 27 that act as a valve-opening limiter. The flow section of the opening of the valve during dispensing stages (FIG. 3) is smaller, about three to four times smaller, than the flow section during suction stages (FIG. 4). It can also be said that the first flow section for dispensing is about 60% to 80% smaller than the second flow section for suction. In other words, it presents a section that is about 20% to 40%, and preferably 30%, of its section during a suction stage. Consequently, the head loss through the valve 3 during a dispensing stage (FIG. 3) is substantially or considerably greater than the head loss through the valve 3 during suction stages (FIG. 4).

Reference is made briefly below to FIG. 5 which shows the dropper dispenser of document DE 20 2016 102 192 U1 during a dispensing stage. A dispenser head 2AA can be seen that forms a cannula 24AA below which a valve 3 is arranged that may be identical in every way to the valve used in the present invention. The cannula 24AA does not have ribs or fins 27 acting as a valve-opening limiter, such that the valve 3 can open freely without being hindered by any structure. The flexible flaps 32 may thus move apart freely and form an opening 33 with a large flow section. It can be said that the flow section of the opening 33 is directly proportional to the squeezing force generated by the user on the squeezable reservoir. When the user squeezes hard, a large quantity of fluid flows through the opening 33 of the valve 3 and through the cannula 24AA, so that the fluid is dispensed in the form of a continuous stream, and not in the form of distinct and separate drops. The function of the opening limiter 27 of the present invention can be seen directly from FIG. 5.

Reference is made below to FIG. 6 in order to describe a dropper dispenser constituting a second embodiment of the invention. The reservoir (not shown), the valve 3, and the support bushing 4 may be strictly identical to those of the first embodiment. The dispenser head 2′ differs from the first embodiment only at the inlet 26 of the cannula 24′ defining the valve-opening limiter. Specifically, it can be seen that the inlet 26 forms a bottleneck 27′ that reduces the flow section of the cannula 24′. It should be observed that the bottleneck 27′ forms a substantially frustoconical flaring section. The bottleneck 27′ also forms an abutment zone 27b against which the wall 31 can come into leaktight abutment. Specifically, the abutment zone 27b is in the form of a continuous and slightly frustoconical roof against which the non-pierced solid portion of the wall 31 can come into leaktight abutment. Thus, the fluid does not spread to the annular holding flange 23. It should also be observed that the abutment zone 27b extends over the major portion of the radial area of the flaps 32, limiting movement of the flaps even more than in the first embodiment. It should be said that there is practically no free deformation of the flaps 32, such that the cross-shaped opening 33 is considerably limited. Thus, it can readily be understood that the head loss is high, such that a very small quantity of fluid arrives at the outlet 25. The user must squeeze very hard on the reservoir during dispensing stages.

FIG. 7 shows a third embodiment of the invention that differs from the preceding embodiments mainly in that the cannula 24″ is axially movable relative to the valve 3. The inlet 26 of the cannula 24″ forms a stroke-opening limiter 27″ that defines an abutment zone 27b against which the deformable wall 31 comes into leaktight abutment during dispensing stages. Furthermore, the inlet 26 is not formed integrally with the remainder of the dispenser head 2″. Specifically, the inlet is connected via a thread 28 that makes it possible to move the cannula 24″ in axial manner away from, or closer to, the valve 3. Moving the cannula closer creates a more constricted opening of the valve 3, while moving the cannula away creates a larger opening of the valve 3. The user can thus adjust as desired the head loss through the valve 3. An elderly person, or a child, with less strength can loosen the cannula 24″, whereas a strong person can tighten the cannula 24″ so as to move it closer to the valve 3.

Although the opening limiters of the above-described embodiments are made integrally as a single piece with the cannula, the fourth embodiment in FIG. 8 uses an opening limiter 6 that is constituted by a separate part that is fitted inside the dispenser. Specifically, the limiter 6 includes a dome 61 that defines a small central opening 62 and an abutment zone 6b. The dome 61 is connected to a fastener collar 64 via a connection section 63. The collar 64 may be wedged between the anchor collar 36 and the annular flange 23. When the valve 3 is deformed during the dispensing stage, it comes into bearing contact against the abutment zone 6b of the dome 61. Thus, in this fourth embodiment, the dispenser head 2′″ includes a cannula 24′″ that can be substantially identical to the dispenser head in the above-mentioned document DE 20 2016 102 192 U1.

It is shown above that the valve-opening limiter may be formed directly by the cannula or by a separate fitted part. Although not shown, it is also possible to imagine that the opening limiter is incorporated directly in the valve, which valve thus defines two distinct flow sections depending on the direction of flow of the fluid. The embodiments shown in the drawings generally seek to interrupt the symmetry of flow through a valve that is symmetrical, but making a valve that is intrinsically asymmetrical also corresponds to the spirit of the invention.

1. A dropper dispenser comprising:
a fluid reservoir including at least one movable wall so as to put the fluid in the reservoir under pressure;
a cannula having an inlet that is fed with fluid and an outlet that is designed to form a drop of fluid; and
a valve that is arranged between the fluid reservoir and the cannula so as to control firstly the flow of fluid from the reservoir into the cannula, and secondly the flow of fluid, and possibly air, from the cannula into the reservoir, the valve remaining closed in the absence of sufficient fluid pressure, the valve, when subjected to sufficient pressure from the fluid in the reservoir, defining an opening having a flow section that is proportional to the force exerted on the movable wall of the reservoir;
the dropper dispenser being characterized in that it further comprises a valve-opening limiter so as to limit the opening of the valve while fluid is flowing from the reservoir into the cannula, so as to create additional head loss that reduces the flow of fluid through the cannula.

2. A dropper dispenser according to claim 1, wherein the valve-opening limiter includes an abutment zone against which the valve comes into abutment while fluid is flowing from the reservoir into the cannula.

3. A dropper dispenser according to claim 1, wherein the valve-opening limiter is situated at the inlet of the cannula.

4. A dropper dispenser according to claim 1, wherein the valve-opening limiter is formed integrally with the cannula.

5. A dropper dispenser according to claim 4, wherein the abutment of the valve against the limiter creates leaktight annular contact around the inlet of the cannula.

6. A dropper dispenser according to claim 1, wherein the valve-opening limiter is formed by a separate part that is interposed between the valve and the cannula.

7. A dropper dispenser according to claim 1, wherein the valve-opening limiter forms a flow-section constriction towards the cannula.

8. A dropper dispenser according to claim 1, further comprising adjustment means for adjusting the position of the valve-opening limiter relative to the valve.

9. A dropper dispenser according to claim 1, wherein the valve comprises a deformable movable wall that is pierced by a cross-shaped slot that defines adjacent flexible flaps, the deformable movable wall coming into abutment against the valve-opening limiter, at least one portion of the flexible flaps advantageously coming into abutment against the valve-opening limiter.

10. A dropper dispenser according to claim 9, wherein the valve further comprises an anchor collar that is mounted in stationary manner relative to the reservoir, and an annular flexible membrane that connects the anchor collar to the deformable movable wall, such that the deformable movable wall is moved relative to the anchor collar by deforming the annular flexible membrane under the effect of the flow of fluid in one direction or in the other.

11. A dropper dispenser according to claim 1, wherein the valve presents two distinct flow sections, namely a first flow section for dispensing while fluid is flowing from the reservoir into the cannula, and a second flow section for suction while fluid, and possibly air, is/are flowing from the cannula into the reservoir, the first flow section for dispensing being limited by the valve-opening limiter, such that it is less than the second flow section for suction.

12. A dropper dispenser according to claim 11, wherein the first flow section for dispensing is three to four times smaller than the second flow section for suction.
